(19) United States
(12) Patent Application Publication
(10) Pub. No.: US 2008/0249874 A1
(43) Pub. Date: Oct. 9, 2008

(54) Ubiquitous Music and Multimedia Service System and the Method Thereof

(76) Inventor: Dong-Wook Seo, Seoul (KR)

Correspondence Address: IPLA P.A., 3580 WILSHIRE BLVD., 17TH FLOOR, LOS ANGELES, CA, 90010, US

(21) Appl. No.: 12/064,941

(22) PCT Filed: Jul. 19, 2006
(86) PCT No.: PCT/KR2006/002833

§ 371 Date: Feb. 26, 2008

(30) Foreign Application Priority Data
Aug. 31, 2005 (KR) 10-2005-0080467
Jul. 19, 2006 (KR) PCT/KR2006/002833

(51) Int. Cl. G06Q 30/00; G06Q 20/00; G01C 21/00

(52) U.S. Cl. 705/14; 705/26; 701/300

(57) ABSTRACT

The characteristics of this invention consist of the following stages: the consumer connects to wire or wireless internet, mobile communication network, or digital broadcasting network through his/her terminal device; the consumer searches for and selects music and multimedia data; the consumer appoints the output device for the selected music and multimedia data; the music or multimedia data is played by the above selected output device; and the consumer and related business end settles the charges.

### TECHNICAL FIELD

As a system and method of a newly contrived concept in preparation for the ubiquitous era, this invention has the characteristic of accomplishing events and appreciation of media by command of the consumer through use of a personal terminal device that allows the instant playback of music or multimedia data from a player close to the consumer or any output device that the consumer chooses. Also by using a location base service, the location of the consumer is automatically recognized and makes possible the playback of selected music from speakers installed near the consumer position through a server connected to LAN or wireless internet.

Furthermore, it is a very convenient service method that allows the request and listening of music anytime, anywhere through a reservation service.

### BACKGROUND ART

As an example of past technology in this field, when wanting to listen to certain music while conversing, customers at a coffee shop would write a music request on a piece of paper and submit it to the person in charge of music. The next step in the process would be for the person in charge of music to gather such requests from the customers, search for the requested music from the collection of CD albums, and play the music through an audio device. For such method, music requests must be made directly to a person such as a DJ, and after the DJ searches for the music, the person must play the music him/herself, and therefore a person in charge of the music is necessary. Furthermore, it is difficult to predict how many people are waiting for his/ her song and when a certain person's request will be played. Sometimes the order of requests are changed or a request is omitted according to the subjective preference of the DJ. Also, there is a limit in location because music is played only inside the coffee shop, and listening to music in places such as outside, at a park, or shopping mall is a concept that cannot be even thought of in such circumstances. The time has come for a service method in which the consumer prefers to lead and participate him/herself, and at times use a music service that has characteristics of an event giving out certain music as a present to someone else.

### DISCLOSURE OF INVENTION

### Technical Problem

For the realization of this invention, technological challenges exists as follows. First, the consumer connects to the main server (400) that provides this service through his or her own wire or wireless terminal device (such as cellular phone, PDA, or laptop computer). Because a database server (500) that contains much music or multimedia data is connected to the main server, the consumer can select data from a variety of music or multimedia data, and this data can be played back at the time the consumer wants, at the place the consumer wants, and through the output device the consumer wants. Also the location information of the consumer is automatically recognized through the location base service (LBS), and therefore, makes possible the output from the closest audio device or consumer selected output device through the automatic decision of which member shop the consumer is at among the member shops provided through the service of this invention.

### Technical Solution

The above explained invention provides the service of enjoying music and multimedia requested through a terminal device anytime, anywhere, alone or with others.

### Advantageous Effects

By providing a service in which the consumer can enjoy music or multimedia data alone or with others at a preferred time and space through a personally owned terminal device in an ubiquitous environment and also present music gifts that transcends time and space including video messages, this invention is a convenient as well as simple and has its effect in the impression that the consumer initiates and participates in the process.

In expanding such aspect, in times of birthdays or other special events presenting a music gift at a wanted time or place or hosting a surprise event can augment the influence of such service on societal culture.

Furthermore, the satisfaction of the consumer is high because he/she him/herself can initiate the purpose of enjoying media and presenting gifts and events. Member shops can maximize profits as more and more consumers visit member shops, advertisers can achieve publicity effects to consumers by exposing their ads during service, and communication or broadcasting networks can earn additional profits from the increased use of their current networks. Due to such effects, the economic consequences or the development of related businesses are predicted to be immense.

With the arrival of the ubiquitous era, the technology to grant individual addresses to all devices has become possible. Therefore, this invention can be called a true ubiquitous technology that makes the enjoyment of music and multimedia for anyone, at any place, at anytime, and through any terminal device possible whether it be alone or in participation with other people.

### BRIEF DESCRIPTION OF THE DRAWINGS

FIG. 1 is a block organization chart that explains this invention during operation.

FIG. 2 is a flow chart of FIG. 1 during operation.

<Description of the elements in the drawings>
100. Consumer terminal device
200A, 200B, 200C. member shop(A˜C)
300A, 300B, 300C. output device(A˜C)
400. Server
500A. Music/Multimedia Database (DB)
500B. Member/member shop/location/log information database
500C. Database of advertisement/publicity/consumer analysis/charge payment
600. Signal convertor for output device operation

### BEST MODE FOR CARRYING OUT THE INVENTION

The below figures are for reference to explain in further detail, but the figures are used to show examples and the claim range of this invention is not limited to the below figures.

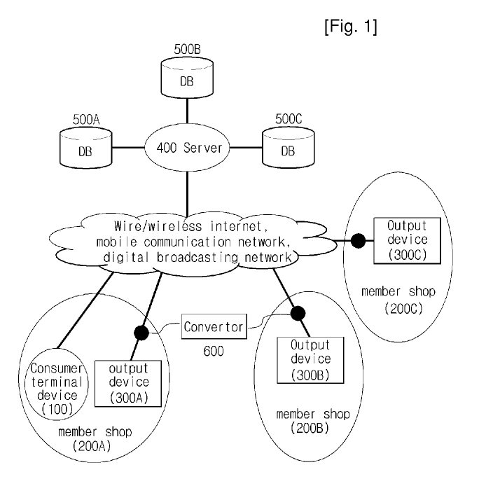

FIG. 1 is a block organization chart that explains this invention during operation. It is possible for the consumer at all times to use a personal terminal device (100) to connect to the server (400) of this invention at anytime, anywhere through wireless internet, mobile communication network, or digital broadcasting network. Here, terminal devices (100) includes wire terminal devices, so the server can be connected to through wire internet (LAN), but for the convenience of explanation, from this point on explanation will be centered around wireless internet or mobile communication network environments using wireless terminal devices such as a cellular phone. In FIG. 1, the consumer arrives at a certain member shop (200A) while in transit, and, for example, connects to the main server of the service management company while resting in order to use the service of this invention. At this time, the server can recognize the location of the consumer terminal device as well as the location of the member shop where the consumer is located. Of the many methods of recognizing location, utilization of location base service (LBS) or GPS, inputting the assigned unique address (IP) of the member shop or the address of the output device (300A) installed within the member shop, close range wireless communication method, or non-contact scanning method, and others can be used to send location information to the server. Examples of close range wireless communication method between a terminal device (100) and member shop (200A) or terminal device (100) and output device (300A) are UWB, Bluetooth, IRDA, ZigBee, NFC, WIFI, SDR, etc, and in the instance a reader is attached to the terminal device, non-contact scanning methods include RF tag, bar code, graphic code, etc reading methods. Conclusively, whether it is automatic or manual, when using a specific technology, it must be assumed that always the terminal device location, member shop location, and the output device location can be selectively recognized on the server (400). As a more convenient method, when the consumer visits the member shop, if the server connection method is generated on the terminal device of the consumer in the form of a short or long message, the consumer may simply press a button to easily make initial connection to the main server. After the consumer undergoes a process in which the consumer confirms the correspondence of the consumer location and the member shop location, the consumer may then search for and select music on his/her terminal device.

The consumer selects the list of music/multimedia data he/she wishes to enjoy on the screen of the terminal device by searching the music/multimedia data list provided by the server or directly inputting the data. At this time when the consumer selects the music and multimedia data, there is a method of suggesting a music genre selection to the consumer at the member shop. This is due to the necessity of eliminating cases in which the consumer selected music is completely different from the music genre that the member shop presses for. In relation to the music genre the member shop prefers, when the consumer selects a music, both a positive system, in which the member shop presents possible music genres for the consumer to select, and a negative system, in which the member shop presents prohibited music genres for the consumer to avoid, should be provided. Such decisions of the consumer can be made immediately on the spot and reservations can be made beforehand. Reservations can be made not only from which member shop or which output device, but also the time of output for special events can be reserved. Generally, if an output time is not reserved output is done in order of reservation, but in the instance a special time is designated, an operation that remembers the time of output is possible. Such sample when used for the purpose of events is very effective and appropriately the service utilization fee becomes higher. Furthermore, in the stage in which the consumer plays the music and multimedia data, if a consumer can insert a prerecorded voice message or mail in his/her own voice at the start, middle, or end of playback, a special meaning to someone can be added to the music and multimedia that is being played, multiplying the effectiveness of this service.

A member shop shown in FIG. 1 makes possible the connecting to many servers simultaneously and takes on a variety of forms. Examples of those forms are coffee/tea rooms, cafes, franchise stores, event halls, restaurants, parks, shopping malls, beaches, amusement parks, baseball parks, trains, planes, and other places where people gather, and individual homes as well as public places such as certain buildings or companies are possible. An essential factor a member shop (200A˜200C) must possess is fulfilled if it has an output device (300A˜300C). Also, a member shop can connect to the server that provides the service of this invention at anytime by many ways, and not only can reserved music and multimedia data lists of the above mentioned member shop be checked in realtime, but the power to set, change, and delete music genres unique to the member shop can be granted. The power to change or delete reserved list data after comparing customers' reserved list and the member shop music genre is also granted. However, member shop visiting consumers can only confirm the currently reserved and waiting music and can only delete or change his/her reserved or requested music.

An output device is an audio and/or video device that can generate music or multimedia in amounts enough for many people to enjoy. Examples of such are general speakers in a home or public place, televisions, car amp, speakers within a building, electric signs on a street or in a park, information monitors or advertising monitors in a subway or public facility, and examples also extend to personally owned terminal devices such as cellular phones, PDA, PMP, PMC, PSP, NP3P, and laptop computers, therefore being so various that it is difficult to list every type there is. Also, monitors for broadcasting at broadcasting centers can be included. If the output device is for analog signals as shown in the figure, a converter (600) apparatus to change the signals for the playing of music and multimedia can be added. Here, the convertor (600) apparatus is a possible addition even in PC forms.

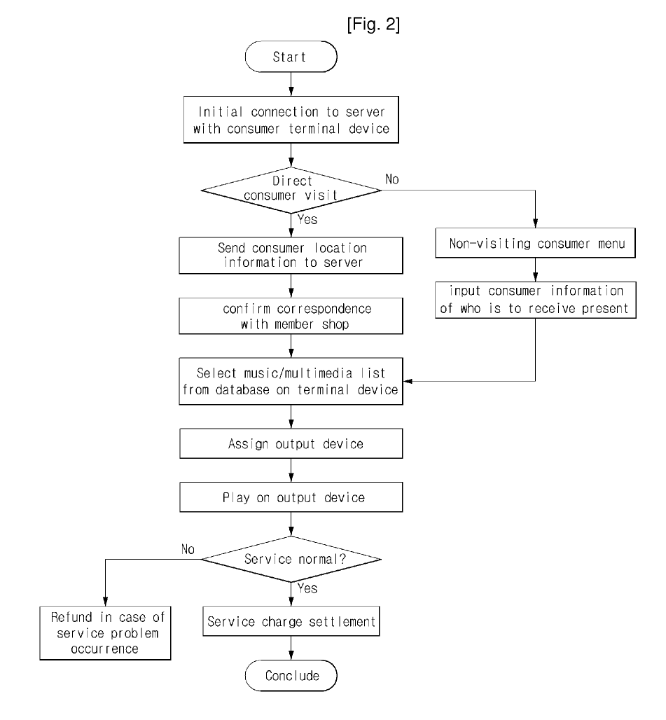

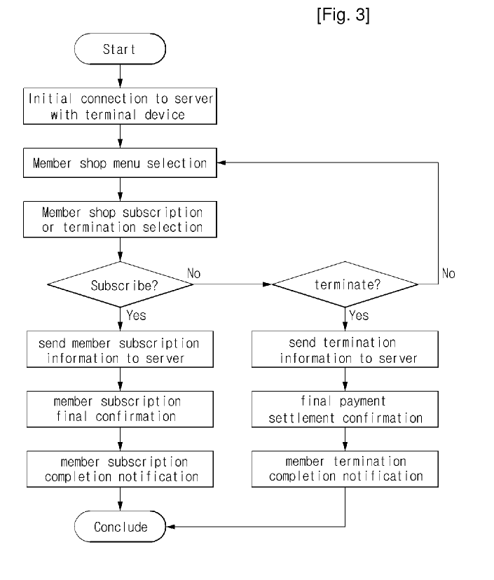

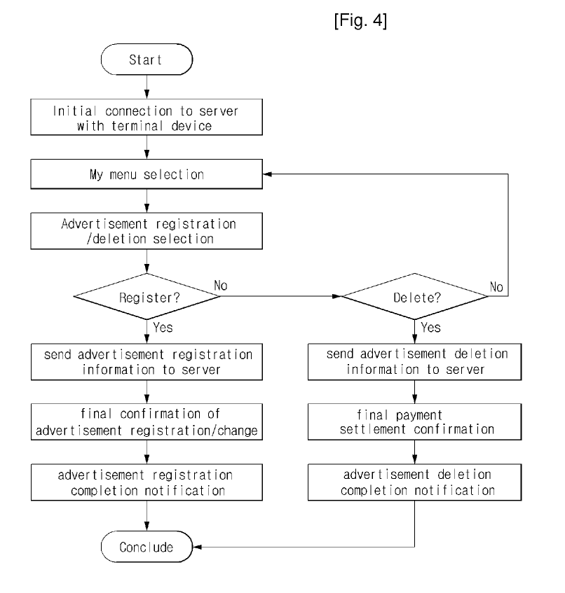

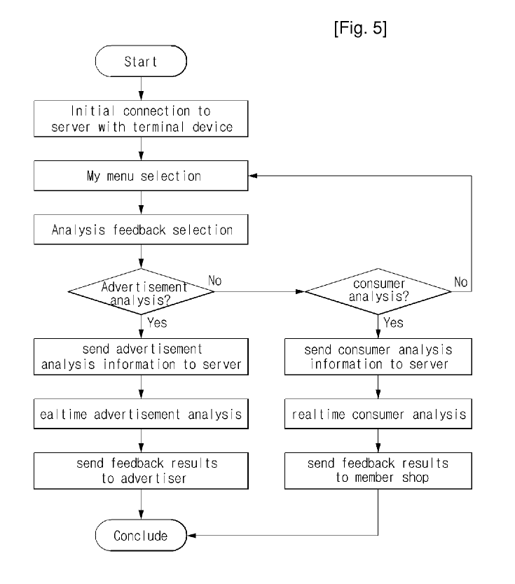

FIG. 2 shows the service concept of this invention in an easily understandable flow chart.

FIG. 3 is a flow chart that shows the subscription or termination of a member shop. With this service, initially the member shop contract is done manually as is general contracts, but once the service becomes active, by making member shop sub-scription and termination processes possible through server connection, the sub-scription or termination as a service member shop is planned to be as convenient as possible. The sequence of such is, first, after initially connecting to the server, the sub-scription or termination menu is selected from the member shop menu. Then subscribe or terminate is selected. If subscribing a member shop, the subscription related information in a set format is sent to the server and undergoes a confirmation procedure. With the subscription consent and completion, the member shop is notified of this and the subscription procedure is concluded.

FIG. 4 shows the procedure in which the member shop or advertiser directly registers, changes, or deletes advertisement related digital file. After the member shop or advertiser initially connects to the server in order to directly manage his/her advertisement, for example on personal homepages, a page in the form of “My Menu” can be connected to. When newly registering or registering after changing the advertisement, after selecting advertisement registration, the advertisement related information, for example the information when entering the name of the advertisement data saved on a terminal device, is sent to the server. The related digital file is also uploaded and undergoes a processing procedure on the server, then after the member shop or advertiser is notified of the final results, the registration procedure is concluded. Similarly, when deleting advertisement data, after selecting the deletion menu, the inputted deletion related information is send to the server. After the payment related settlements are handled on the server, the completion of the final deletion is notified of, and the deletion procedure is concluded.

FIG. 5 illustrates the procedure for advertisement or consumer analysis feedback. In the instance the advertiser or member shop wishes feedback results through advertisement effects or realtime consumer analysis, after initially connecting to the server, analysis feedback is selected from the menu. When advertisement analysis or consumer analysis or similarly related analysis information is inputted and sent to the server, the server processes this and notifies of the final feedback results to the advertiser or member shop terminal device, concluding the procedure.

The ubiquitous music and multimedia entertainment service system explained up to this point can be inferred to recognize its claims much passed the ranges of possible technological application.

1. Stage in which the consumer connects to the server using his/her terminal device through wire or wireless internet, mobile communications network, or digital broadcasting network;
Stage in which the consumer related location information or member shop related location information is provided to the server;
Stage in which the consumer or member shop owner selects the music and multimedia data;
Stage in which voice or text mail, picture, avatar character, or video clip that was pre-made or made by a consumer or individual is entered into the server, or voice or text mail, picture, avatar character, or video clip that was pre-made or made by a consumer or individual is sent to a consumer, individual or member shop owner;
Stage in which an output device, which can playback the above selected music and multimedia or can playback such data, installed in a member shop is decided;
Stage in which the consumer or individual or member shop owner is charged and makes payment of the service to be used;
Stage in which the music and multimedia data is received from the server and played on the above decided output device;
Stage in which the consumer or individual or member shop owner settles the charged payments of the utilized service, and the above mentioned stages as a characteristic of a ubiquitous music and multimedia service method.

2. As in claim 1, a terminal device stated above is,
A device that can be connected to wire or wireless internet such as a cellular phone, PDA phone, smart phone, laptop computer, PC, DTV, IP-TV, Digital Cable TV, internet phone, PMP, PSP, MP3P, etc;
A device for connecting to a mobile communication network or a digital broadcasting network;
A device that can receive a Location base service(LBS); and
A device that has or has embedded within it sensors such as a gyroscope or an altimeter so it is possible to recognize different floors within the same building;
One of the above as a characteristic of a ubiquitous music and multimedia service method.

3. As in claim 1, an output device stated above is,
An audio/video device in the home, office, building, store such as speakers, TV, audio player, PC, DTV, IP-TV, Digital Cable-TV;
An audio/video device installed in a public facility such as a swimming pool or lobby;
An audio/video device installed outdoors such as streets, amusement park, lobby;
An audio/video device installed on transportation means such as subway, train, airplane, ship, automobile;
A personal mobile terminal such as cellular phone, PDA, PMP, PMC, PSP, MP3P, laptop computer; and
Terminal device of the consumer;
One of the above as a characteristic of a ubiquitous music and multimedia service method.

4. As in claim 1, the member shop stated above is,
At a wire or wireless environment such as at home, in the car or shop/store, in a building, at a park, city, amusement park, theme park, or simply inside or outdoors, instance in which an audio or multimedia device or terminal device, which can receive digital broadcasting, mobile communication service, or VoIP service possible of receiving audio data through a wire or wireless internet provider (IP), can be possessed or installed,
A member who in private capacity subscribes to and uses this service can become a part of the member shop as a characteristic of a ubiquitous music and multimedia service method.

5. As in claim 1, the database stated above is,
Has music or multimedia data stored, and/or includes an Electronic map or a Geographical information system (GIS) that has location information of service member shops saved within the database as a characteristic of a ubiquitous music and multimedia service method.

6. As in claim 1,
Charge, payment or settlement is,
In applying for and receiving the service of this invention by use of a terminal device, though the consumer can pay all the service utilization fees, a third person can pay all or part of the fees on behalf of the consumer as a profit business model method as a characteristic of a ubiquitous music and multimedia service method.

7. As in claim 6,
Service utilization fee is,
Including the fee that must be payed in order to receive music and multimedia data in the form of downloads or streaming; or a network utilization fee that is payed for connecting to networks such as a wire or wireless internet, a mobile communication network, or a broadcasting network; or a separate payment of fees for settling charges; all or part of the whole cost the consumer must pay as a characteristic of the ubiquitous music and multimedia service method.

8. As in claim 6, a third person is,
Excluding the consumer who first apply for use of the service through a terminal device,
Individual member shops; or the headquarters or branch in the instance of member shops in a chain; or a communications or broadcasting service business;
or an advertising or publicity or sales promotion business; or an individual member; or the manager of this service and a separately contracted business person or management agent for necessary purposes of the service; at least one of the above as a characteristic of a ubiquitous music and multimedia service method.

9. As in claim 6,
A profit business model is,
On the condition that a third person pays for all or part of the utilization fees of the consumer,
At the time during or before and after download or streaming in order to playback the music or multimedia data the consumer has requested on the output device, by generating video advertisement, still advertisement, or regional advertisement based on the location base system (LBS) of the consumer terminal device or output devices of this service, the possible appropriation of all or a part of the expenses as an added characteristic;
In making expansion of the service of this invention possible not only to the communications field, but also to the broadcasting field,
A variety of broadcasting forms are applicable including digital broadcasting (digital ground wave and digital satellite broadcasting), general airwave broadcasting, satellite DMB broadcasting, ground wave DMB broadcasting, radio broadcasting, cable broadcasting, etc;
A profit business model by broadcasting the music and multimedia the consumer has requested or broadcasting a voice or text mail, picture, avatar character, or video clip that was pre-made by the consumer in the arranged advertisement time in the middle or before and after the separate programs of each broadcast as an added characteristic;
In the instance a consumer who has visited a member shop wants to use music and multimedia data for personal enjoyment, the member shop or advertiser can provide a download or streaming service to the consumer for free or discount.
Therefore, the consumer can use a limited service for personal use as an added characteristic of a ubiquitous music and multimedia service method.

10. As in claim 9, advertisement is,
The stage in which the advertiser, using a digital camera phone or a camcorder phone, self makes and registers the all or part of the background screen; the advertiser manages the advertisement data on the advertisement database; the charges and payment related to the advertisement data registration and management are settled; the advertisement effect analysis and feedback results are sent to the advertiser; the consumer location information is automatically recognized to the server by the location base service; whether or not the consumer is in a certain advertising area is judged; and the advertisement data requested and registered for the above certain advertisement area is automatically revealed to the consumer terminal device;
For advertisement registration procedures, the individual or member shop owner or the advertiser including the consumer must provide an advertisement in the form of a digital file and directly or indirectly register it to the server;
For the charging method of the advertisement, the registered data will be charged by file size or by packet size at a measured rate system, frequency, or a regular fixed price rate when downloading or streaming;
Or regarding the advertisement format, before or after the stage in which the music and multimedia data is received from the server and played through the assigned output device, in the instance a consumer reserves or requests the advertisement or publicity for enjoyment or presentation of music and multimedia data, the reserved or requested and playback result can be included within the format of personally made short messages (SMA) or multimedia messages (MMS) or URL Callback format to be advertised on the consumer terminal device and/or the terminal device of the person receiving or the member shop terminal device. The request result content of music and multimedia data information such as singer and/or title, related charge information, and/or consumer review or gifts can be included in URL Callback format or short messages or multimedia messages, and therefore consumers who sees the advertisement can use the service for free/discount/charge;
The time of charge of advertisement is prepayment, post payment, or concurrent payment as an added characteristic of a ubiquitous music and multimedia service method.

11. As in claim 1,
A member shop can connect to the server provided by the service of this invention;
The member shop can check the currently reserved music and multimedia data list in realtime;
The member shop has to power to set, change, and delete music genre unique to the shop;
Or the member shop can directly request or set, change, and delete music and multimedia;
It also has the power to compare the data of the reserved list and the member shop music genre and regulate, change, and delete the data on the reserved list;
The possession of a method to prevent the member shop from unilaterally playing music and multimedia which the consumer selected freely as an added characteristic;
In the method of suggesting the possible choices of music genre of the member shop the consumer is currently using or plans to use during the stage in which the consumer selects the music and multimedia data;
The provision of a positive system in which the member shop suggests to the consumer the music genres that can be chosen from;
The provision of a negative system in which the member shop presents the music genres prohibited from choice and allowing the consumer to select music other than those prohibited, and the provision of both systems as an added characteristic of a ubiquitous music and multimedia service method.

12. As in claim 1,
As the stage and method of the provision of consumer related location information or member shop related location information to the server, the consumer inputs the wire or wireless phone number of the member shop into the terminal device or;
The consumer inputs a different person's unique identification number such as a cellular phone number or IP address of the terminal device into his/her terminal device, and the location of the other person can be told to be within or outside of the member shop through LBS or;
The consumer inputs the assigned internet address (IP or WINC) or the broadcasting channel of the member shop into the terminal device or;
The consumer inputs the internet address (IP or WINC) or the broadcasting channel of the output device of the member shop;
The stage in which by using the function built within or attached outside the terminal device possessed by the consumer or member shop, the member shop related bar code, graphic code, or RF tag is scanned or read;
The stage in which the information or data collected sent after connecting to the server;
The data collected by close range wireless communication between the consumer terminal device and devices in the area or scanning recognition method is sent to the server or;
The selection of which method of automatically sending the consumer terminal device location information discerned by the location base service (LBS) to the server as an added characteristic;
For the stage in which the consumer related location information or member shop related location information is provided to the server, due to many member shops are located on many floors of one building though the location base service recognizes those shops as the same coordinates, each member shop can be assigned different internet addresses (IP), and therefore the consumer location as well as the member shop location in which the consumer is located can be clearly discerned as an added characteristic;
In the instance a consumer visits a member shop by use of the location base service, the connection method to the main server of the service of this invention can be automatically generated to the consumer terminal device in the form of short message (SMS) or multimedia message (MMS). Therefore, the consumer can simply press a button and easily make initial connection to the main server, and such simple initial connection method as an added characteristic;
The short message (SMS) or multimedia message (MMS) output on the terminal device of the consumer is also provided through mobile communications network, wire or wireless internet, or digital broadcasting network or;
Provision by a wireless communications means installed within the member shop as an added characteristic;
Stage in which the consumer, while connected to the above server, inputs another's unique identification number of the terminal device such as the cellular phone number or IP address of the other's terminal device;
Stage in which the location of the above terminal device of another person due to the location base system is sent to the server automatically;
Stage in which the above server sends the music and multimedia data selected by the consumer to a member shop closest to another's terminal device;
Because the above music and multimedia data gift is presented when played on a member shop output device, the instance in which the member shop related location information does not need to be entered directly by the consumer as an added characteristic;
As a method of selecting a member shop by searching for the member shop the consumer wants or selecting from a member shop list, the provision of member shop related information as and added characteristic of a ubiquitous music and multimedia service method.

13. As in claim 12,
For the provision of consumer related location information or member shop related location information to the server,
Inclusion of the addition of a stage for inputting a separate password by the consumer or member shop as a characteristic of the ubiquitous music and multimedia service method.

14. As in claim 1,
In the stage in which the consumer or member shop owner selects music and multimedia data from the database;
General consumers at a different location wishing to present a music and multimedia gift to a consumer visiting a member shop, planning on visiting a member shop, or even one who has not but may visit a member shop can connect to the server provided by the service of this invention;
The member shop which the consumer will visit or already has visited can be selected and the music and multimedia searched, requested, and reserved;
The currently reserved music and multimedia data list of the member shop can be checked in realtime;
The power to set, change, and delete only the music or multimedia that was reserved, requested, or registered at the member shop by the person him/herself is provided as an added characteristic;
In the stage where the music and multimedia data is selected at the member shop, it can be played through the connection of the consumer terminal device and an output device within the member shop by a close range wireless communication method;
The above close range wireless communication that can be used are UWB, Bluetooth, IRDA, ZigBee, RuBee, NFC, WIFI, SDR, RF tag, etc, and/or;
After the consumer is provided with his/her selected music and multimedia data directly from the member shop server in the form of download or streaming, because the service of playback by connecting the member shop output device and consumer terminal device using the close range wireless communication means or the instance in which the consumer synchronizes or sends a sound file or multimedia data or contents saved on his/her terminal device to the member shop output device by close range communication, the method of reducing the communications fee of the consumer as an added characteristic;
The reservation status and request status list of current consumers within the member shop can be displayed at all times on the consumer terminal device and PC or terminal devices withing the member shop;
A monitoring system that can perceive the consumers who visit the member shop through an output screen or monitor within the member shop as well as the entire situation of the member shop by the member shop owner when connected to the server as an added characteristic of a ubiquitous music and multimedia service method.

15. As in claim 1,
The stage in which the music and multimedia data is received from the server and played through the assigned output device is,
The stage in which a signal processing converter equipment is added in the middle of the stage of sending the music and multimedia data received from the server to an output device of the member shop;
The converter equipment has the function to process the reciprocal change of digital signals and analog signals;
The converter equipment is realized as a PC (personal computer) or PDA, etc, or;
The converter equipment is realized in a form disregarding whether it is a built-in or attached form such as a multi-functional digital set-top box, broadcasting device, D/A converter, data transformer, amp, and other similar built-in or attached forms, and/or;
The converter equipment can realize major functions by method of software process and not hardware provision, and/or;
If a play list of consumer reserved music and multimedia data is absent, the converter equipment automatically controls the application of the member shop own play list as an added characteristic;
Before the stage in which music and multimedia data is received from the server and played through an assigned output device, in the instance a consumer reserves or requests music and multimedia data for enjoyment or as a present, the reservation or request results can be notified of beforehand on the consumer terminal device, terminal device of the person to receive the gift, or the member shop terminal device in the format of short messages (SMS), multimedia messages (MMS), or URL Callback. The request result content of music and multimedia data such as singer and/or title, related charge information, and/or consumer enjoyment or present can be included in the format of short message (SMS), multimedia message (MMS), or URL Callback, and therefore, the stage in which the enjoyment or present related persons can enjoy it in advance or be notified of the gift information as a characteristic;
By inserting and generating voice message or mail recorded in the consumer's own voice or a text mail, voice mail, or video clip made by the consumer in the middle of or before or after playback including background screen, the stage in which music and multimedia data can be sent to another in an added form with certain playback related meaning or increased value as an added characteristic; or
the stage in which steps for uploading voice or text mail or video clip made by the consumer or an individual to the server is deleted as an added characteristic of a ubiquitous music and multimedia service method.
